(19) United States
(12) Patent Application Publication
(10) Pub. No.: US 2021/0126816 A1
(43) Pub. Date: Apr. 29, 2021

(54) SOUNDING REFERENCE SIGNAL (SRS) TRANSMISSION WITH BANDWIDTH PART (BWP) SWITCHING

(71) Applicants: Alexei Davydov, Nizhny Novgorod (RU); Guotong Wang, Beijing 11 (CN)

(72) Inventors: Alexei Davydov, Nizhny Novgorod (RU); Guotong Wang, Beijing 11 (CN)

(21) Appl. No.: 17/141,139

(22) Filed: Jan. 4, 2021

Related U.S. Application Data
(63) Continuation of application No. PCT/CN2020/075673, filed on Feb. 18, 2020.
(60) Provisional application No. 62/959,073, filed on Jan. 9, 2020.

(51) Int. Cl. H04L 25/02; H04L 5/00; H04W 80/02; H04W 72/04; H04W 76/27

(52) U.S. Cl. CPC H04L 25/0226; H04L 5/0048; H04W 80/02; H04W 76/27; H04W 72/042; H04W 72/0453; H04W 72/0493

(57) ABSTRACT

An apparatus for use in a UE includes processing circuitry coupled to a memory. To configure the UE for 5G-NR communications, the processing circuitry is to decode higher layer signaling received from a base station, the higher layer signaling to configure a plurality of BWPs for UL and DL communication with the base station. A received DCI includes a field triggering SRS reporting. The field also indicates a subset of the plurality of BWPs for the SRS reporting. SRS is encoded for transmission to the base station using a first BWP of the subset of the plurality of BWPs indicated by the field to perform the SRS reporting. An UL communication comprising a PUSCH is encoded for transmission using a second BWP of the plurality of BWPs, the second BWP being non-overlapping with the subset of the plurality of BWPs.

### PRIORITY CLAIM

This application claims the benefit of priority to the following applications:

U.S. Provisional Patent Application Ser. No. 62/959,073, filed Jan. 9, 2020, and entitled “SOUNDING REFERENCE SIGNAL TRANSMISSION WITH BANDWIDTH PART SWITCHING;” and

PCT Application Serial No. PCT/CN2020/075673, filed Feb. 18, 2020, and entitled “5G METHOD OF SRS PARTIAL SOUNDING.”

The above-identified patent applications are incorporated herein by reference in their entireties.

### TECHNICAL FIELD

Aspects pertain to wireless communications. Some aspects relate to wireless networks including 3GPP (Third Generation Partnership Project) networks, 3GPP LTE (Long Term Evolution) networks, 3GPP LTE-A (LTE Advanced) networks, and fifth-generation (5G) networks including 5G new radio (NR) (or 5G-NR) networks and 5G-LTE networks such as 5G NR unlicensed spectrum (NR-U) networks. Other aspects are directed to systems and methods for sounding reference signal (SRS) transmission such as SRS transmission with bandwidth part (BWP) switching.

### BACKGROUND

Mobile communications have evolved significantly from early voice systems to today's highly sophisticated integrated communication platform. With the increase in different types of devices communicating with various network devices, usage of 3GPP LTE systems has increased. The penetration of mobile devices (user equipment or UEs) in modern society has continued to drive demand for a wide variety of networked devices in many disparate environments. Fifth-generation (5G) wireless systems are forthcoming and are expected to enable even greater speed, connectivity, and usability. Next generation 5G networks (or NR networks) are expected to increase throughput, coverage, and robustness and reduce latency and operational and capital expenditures. 5G-NR networks will continue to evolve based on 3GPP LTE-Advanced with additional potential new radio access technologies (RATs) to enrich people's lives with seamless wireless connectivity solutions delivering fast, rich content and services. As current cellular network frequency is saturated, higher frequencies, such as millimeter wave (mmWave) frequency, can be beneficial due to their high bandwidth.

Potential LTE operation in the unlicensed spectrum includes (and is not limited to) the LTE operation in the unlicensed spectrum via dual connectivity (DC), or DC-based LAA, and the standalone LTE system in the unlicensed spectrum, according to which LTE-based technology solely operates in the unlicensed spectrum without requiring an “anchor” in the licensed spectrum, called MulteFire. MulteFire combines the performance benefits of LTE technology with the simplicity of Wi-Fi-like deployments.

Further enhanced operation of LTE systems in the licensed, as well as unlicensed spectrum, is expected in future releases and 5G systems. Such enhanced operations can include techniques for SRS transmission such as SRS transmission with BWP switching.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various aspects discussed in the present document.

FIG. 1A illustrates an architecture of a network, in accordance with some aspects.

FIG. 1B and FIG. 1C illustrate a non-roaming 5G system architecture in accordance with some aspects.

FIG. 2A illustrates an RRC message for SRS resource set configuration, in accordance with some embodiments.

FIG. 2B illustrates the SRS request field in DCI, in some embodiments.

FIG. 2C illustrates non-aligned BWPs for downlink (DL) and uplink (UL) communications, in accordance with some embodiments.

FIG. 3 illustrates higher layer signaling to associate SRS triggering field and SRS resource sets in different BWPs, in accordance with some embodiments.

FIG. 4 illustrates semi-persistent (SP) SRS activation/deactivation using a media access control (MAC) control element (CE), in some embodiments.

FIG. 5 illustrates transient periods associated with BWP switching for SRS transmission, in some embodiments.

FIG. 6 illustrates non-aligned DL BWP and UL BWP, in some embodiments.

FIG. 7 illustrates BWP switching for aperiodic SRS antenna switching with partial sounding, in some embodiments.

FIG. 8 illustrates BWP switching for periodic SRS resource set with antenna switching, in some embodiments.

FIG. 9 illustrates a block diagram of a communication device such as an evolved Node-B (eNB), a new generation Node-B (gNB), an access point (AP), a wireless station (STA), a mobile station (MS), or a user equipment (UE), in accordance with some aspects.

### DETAILED DESCRIPTION

The following description and the drawings sufficiently illustrate aspects to enable those skilled in the art to practice them. Other aspects may incorporate structural, logical, electrical, process, and other changes. Portions and features of some aspects may be included in or substituted for, those of other aspects. Aspects outlined in the claims encompass all available equivalents of those claims.

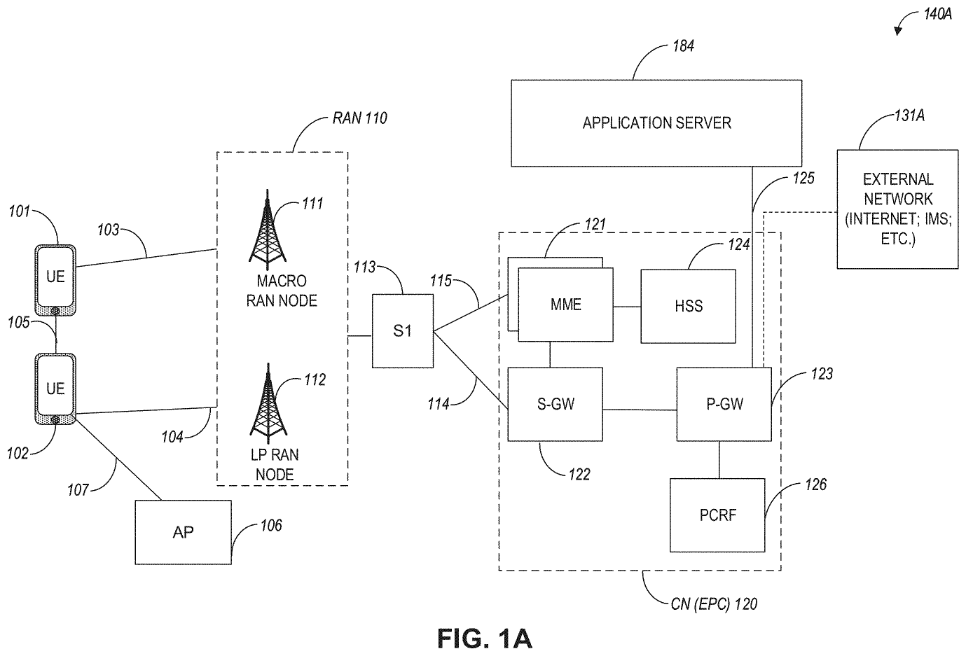

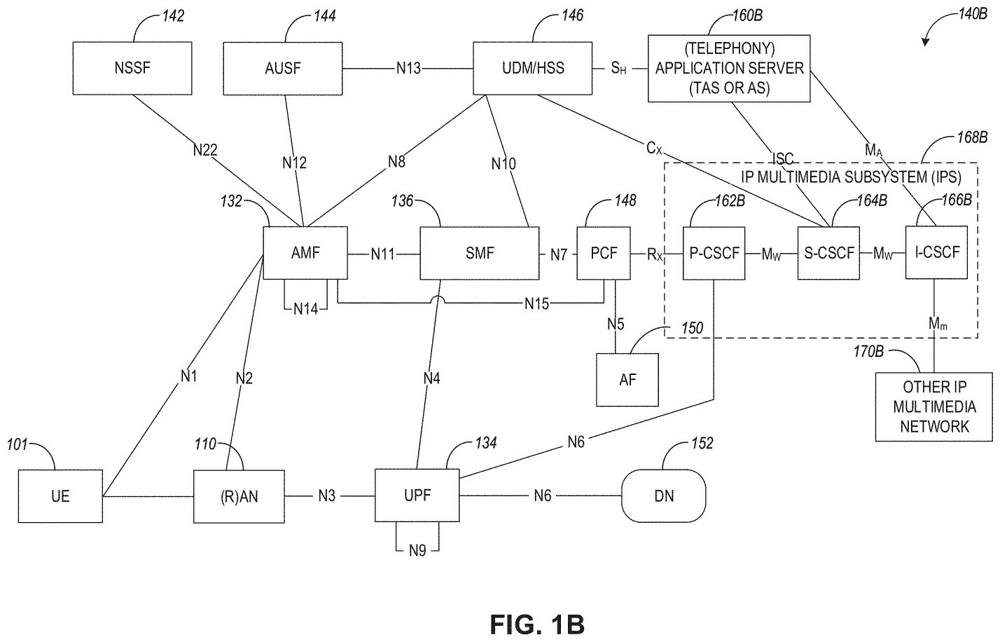

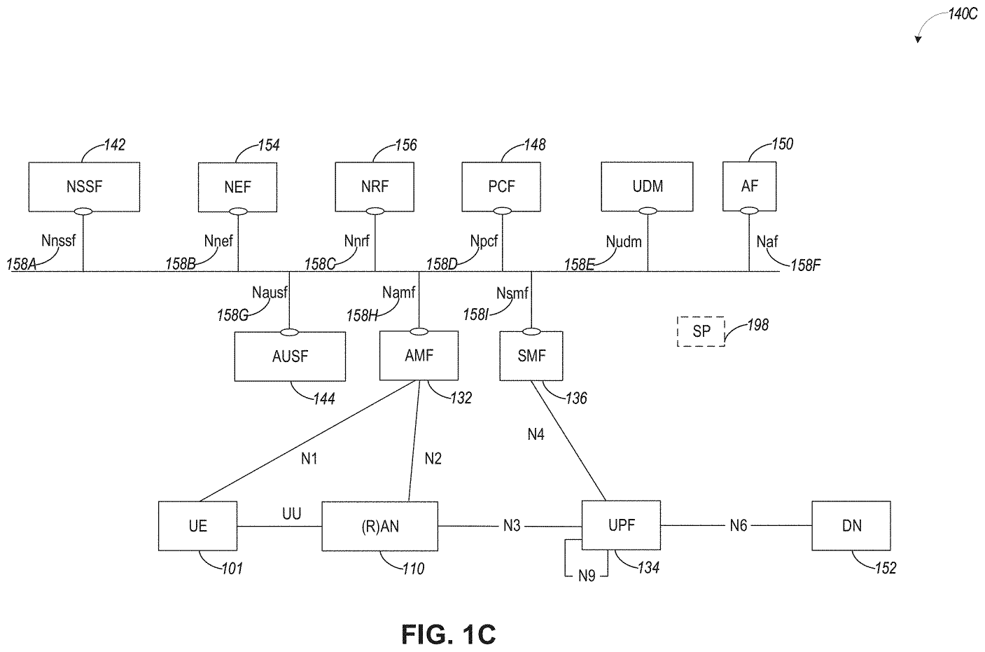

FIG. 1A illustrates an architecture of a network in accordance with some aspects. The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as Personal Data Assistants (PDAs), pagers, laptop computers, desktop computers, wireless handsets, drones, or any other computing device including a wired and/or wireless communications interface. The UEs 101 and 102 can be collectively referred to herein as UE 101, and UE 101 can be used to perform one or more of the techniques disclosed herein.

Any of the radio links described herein (e.g., as used in the network 140A or any other illustrated network) may operate according to any exemplary radio communication technology and/or standard.

LTE and LTE-Advanced are standards for wireless communications of high-speed data for UE such as mobile telephones. In LTE-Advanced and various wireless systems, carrier aggregation is a technology according to which multiple carrier signals operating on different frequencies may be used to carry communications for a single UE, thus increasing the bandwidth available to a single device. In some aspects, carrier aggregation may be used where one or more component carriers operate on unlicensed frequencies.

Aspects described herein can be used in the context of any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and further frequencies and Spectrum Access System (SAS) in 3.55-3.7 GHz and further frequencies).

Aspects described herein can also be applied to different Single Carrier or OFDM flavors (CP-OFDM, SC-FDMA, SC-OFDM, filter bank-based multicarrier (FBMC). OFDMA, etc.) and in particular 3GPP NR (New Radio) by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN. The UEs 101 and 102 utilize connections 103 and 104, respectively, each of which comprises a physical communications interface or layer (discussed in further detail below); in this example, connections 103 and 104 are illustrated as an air interface to enable communicative coupling and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth-generation (5G) protocol, a New Radio (NR) protocol, and the like.

In an aspect, the UEs 101 and 102 may further directly exchange communication data via a ProSe interface 105. The ProSe interface 105 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) can be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some aspects, the communication nodes 111 and 112 can be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and can be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management, and data packet scheduling, and mobility management. In an example, any of the nodes 111 and/or 112 can be a new generation Node-B (gNB), an evolved node-B (eNB), or another type of RAN node.

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-IC). In this aspect, the S1 interface 113 is split into two parts; the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, the capacity of the equipment, the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the EPC network 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VoIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session, a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A can be an IoT network or a 5G network, including a 5G new radio network using communications in the licensed (5G NR) and the unlicensed (5G NR-U) spectrum. One of the current enablers of IoT is the narrowband-IoT (NB-IoT).

An NG system architecture can include the RAN 110 and a 5G network core (5GC) 120. The NG-RAN 110 can include a plurality of nodes, such as gNBs and NG-eNBs. The core network 120 (e.g., a 5G core network or 5GC) can include an access and mobility function (AMF) and/or a user plane function (UPF). The AMF and the UPF can be communicatively coupled to the gNBs and the NG-eNBs via NG interfaces. More specifically, in some aspects, the gNBs and the NG-eNBs can be connected to the AMF by NG-C interfaces, and to the UPF by NG-U interfaces. The gNBs and the NG-eNBs can be coupled to each other via Xn interfaces.

In some aspects, the NG system architecture can use reference points between various nodes as provided by 3GPP Technical Specification (TS) 23.501 (e.g., V15.4.0, 2018-12). In some aspects, each of the gNBs and the NG-eNBs can be implemented as a base station, a mobile edge server, a small cell, a home eNB, and so forth. In some aspects, a gNB can be a master node (MN) and NG-eNB can be a secondary node (SN) in a 5G architecture.

FIG. 1B illustrates a non-roaming 5G system architecture in accordance with some aspects. Referring to FIG. 1B, there is illustrated a 5G system architecture 140B in a reference point representation. More specifically, UE 102 can be in communication with RAN 110 as well as one or more other 5G core (5GC) network entities. The 5G system architecture 140B includes a plurality of network functions (NFs), such as access and mobility management function (AMF) 132, session management function (SMF) 136, policy control function (PCF) 148, application function (AF) 150, user plane function (UPF) 134, network slice selection function (NSSF) 142, authentication server function (AUSF) 144, and unified data management (UDM)/home subscriber server (HSS) 146. The UPF 134 can provide a connection to a data network (DN) 152, which can include, for example, operator services, Internet access, or third-party services. The AMF 132 can be used to manage access control and mobility and can also include network slice selection functionality. The SMF 136 can be configured to set up and manage various sessions according to network policy. The UPF 134 can be deployed in one or more configurations according to the desired service type. The PCF 148 can be configured to provide a policy framework using network slicing, mobility management, and roaming (similar to PCRF in a 4G communication system). The UDM can be configured to store subscriber profiles and data (similar to an HSS in a 4G communication system).

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162BE, a serving CSCF (S-CSCF) 164B, an emergency CSCF (E-CSCF) (not illustrated in FIG. 1B), or interrogating CSCF (I-CSCF) 166B. The P-CSCF 162B can be configured to be the first contact point for the UE 102 within the IM subsystem (IMS) 168B. The S-CSCF 164B can be configured to handle the session states in the network, and the E-CSCF can be configured to handle certain aspects of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some aspects, the I-CSCF 166B can be connected to another IP multimedia network 170E, e.g. an IMS operated by a different network operator.

In some aspects, the UDM/HSS 146 can be coupled to an application server 160E, which can include a telephony application server (TAS) or another application server (AS). The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown). N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures can be service-based and interaction between network functions can be represented by corresponding point-to-point reference points Ni or as service-based interfaces.

In some aspects, as illustrated in FIG. 1C, service-based representations can be used to represent network functions within the control plane that enable other authorized network functions to access their services. In this regard, 5G system architecture 140C can include the following service-based interfaces: Namf 158H (a service-based interface exhibited by the AMF 132), Nsmf 1581 (a service-based interface exhibited by the SMF 136), Nnef 158B (a service-based interface exhibited by the NEF 154). Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

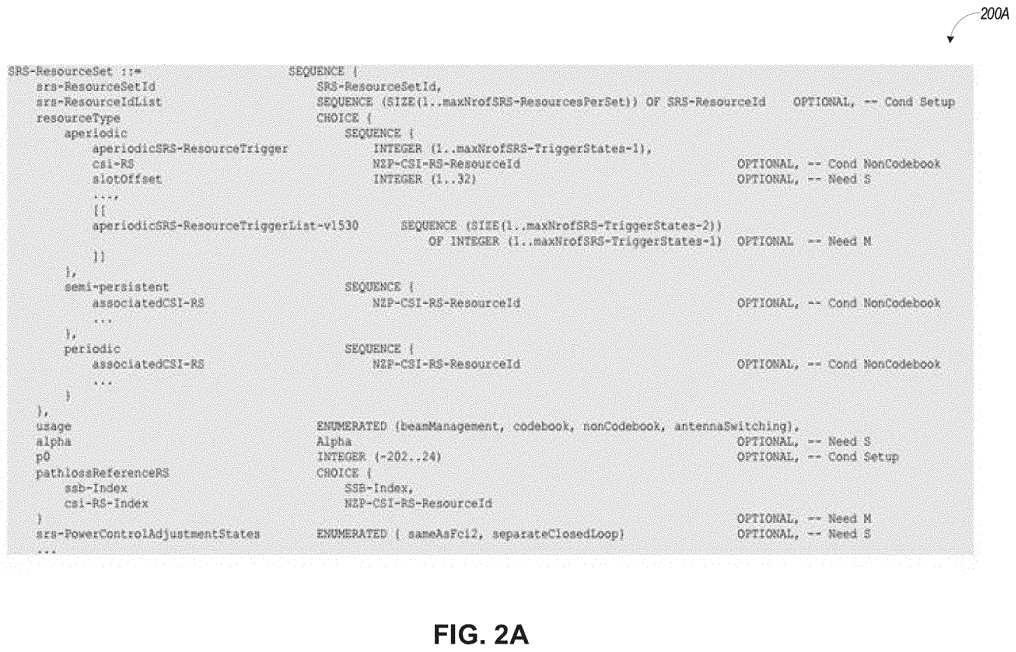

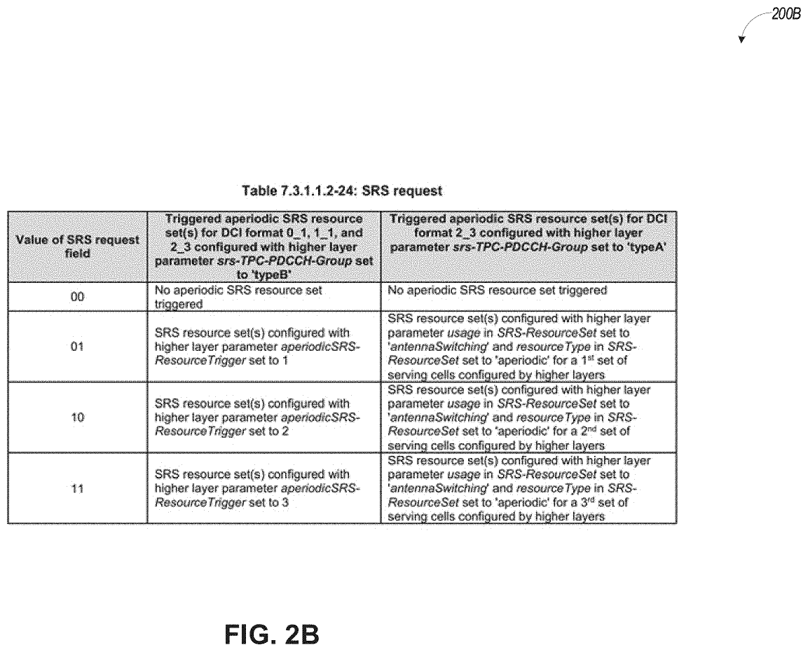

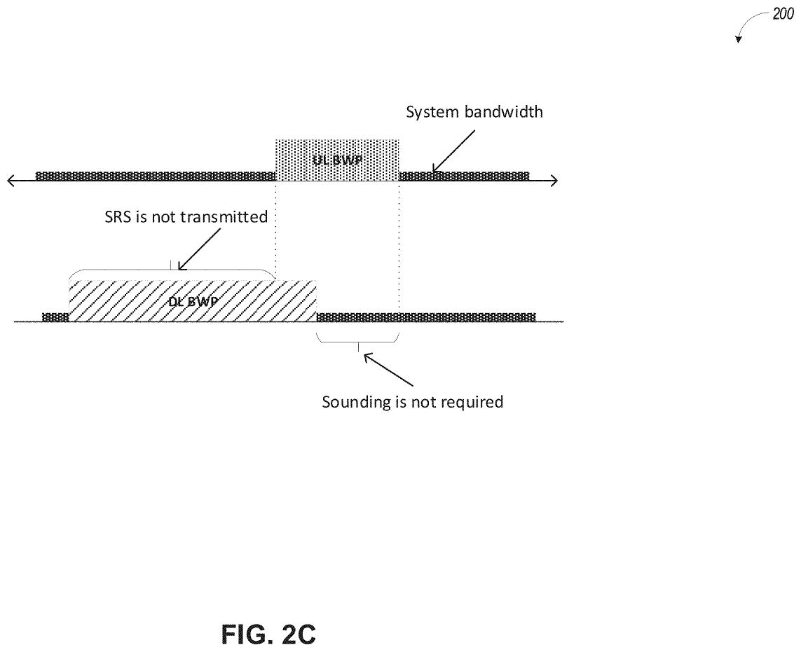

In example embodiments, any of the UEs or base stations discussed in connection with FIG. 1A-FIG. 1C can be configured to operate using the techniques discussed in connection with FIGS. 2A-9.

In 5G NR Rel-15 spec, the UE can be configured with one or more SRS resource set(s). Each SRS resource set can contain one or multiple SRS resource(s). FIG. 2A illustrates an example of radio resource control (RRC) signaling (e.g., a message) 200A for SRS resource set configuration.

In Rel-15, different types of SRS resource sets are supported. The SRS resource set is configured with a parameter of ‘usage’, which can be set to ‘beamManagement’, ‘codebook’, ‘nonCodebook’, or ‘antennaSwitching’. The SRS resource set configured for ‘beamManagement’ is used for beam acquisition and uplink beam indication using SRS. The SRS resource set configured for ‘codebook’ and ‘nonCodebook’ is used to determine the UL precoding with explicit indication by TPMI (transmission precoding matrix index) or implicit indication by SRI (SRS resource index). Finally, the SRS resource set configured for ‘antennaSwitching’ is used to acquire DL channel state information (CSI) using SRS measurements at the gNB by leveraging reciprocity of the channel in TDD systems. In all SRS configurations. SRS transmission outside of the uplink bandwidth part (UL BWP) is not supported.

For SRS transmissions, the time domain behavior could be periodic, semi-persistent, or aperiodic. For aperiodic SRS transmissions, it may be triggered by the field of ‘SRS Request’ in DCI. The field of ‘SRS Request’ could be included in DC format 0_1, 1_1, and 2_3. DCI format 0_is used for uplink scheduling and DCI format 1_1 is used for downlink scheduling.

In the scenario of carrier aggregation, if over some component carriers (CCs) the UE is not configured with a PUSCH/PUCCH transmission, or over some CCs independent SRS power control is configured from PUSCH, then DCI format 2_3 could be used to trigger aperiodic SRS transmission.

For DCI format 2_3, two types of configurations may be defined: Type-A and Type-B. For Type-A configuration, the UE is provided with a set of serving cells and a TPC command for each cell from the set. Type-A configuration can be used to trigger SRS transmission on the set of serving cells. For Type-B configuration, the UE is provided with a TPC command for one serving cell and it can be also used to trigger SRS transmission on that serving cell. FIG. 2B illustrates SRS request field 200B in DCI, in some embodiments.

Bandwidth parts (BWP) can be used in NR for various purposes. For example, BWP can be used for dynamic adaptation of the subcarrier spacing (SCS). For example, a UE can be configured with multiple BWPs where each BWP configuration has a different SCS. When a BWP change (or switch) is indicated to the UE, the SCS of the transmission is changed as well. The other use case example of BWP is power saving. In particular, multiple BWPs can be configured for the UE with different amount of frequency resources (physical resource blocks, or PRBs) to support data transmission under different traffic loading scenarios. BWP containing a smaller number of PRBs can be used for data transmission with small traffic load while allowing power saving at the UE and in some cases at gNB BWP containing a larger number of PRBs can be used for scenarios with higher traffic load.

Since the traffic loading can be different for DL and UL, NR communications may support independent BWP configuration for DL and UL. As a result, SRS transmission with ‘antennaSwitching’ in a general case does not allow the sounding of the channel over PRBs allocated of the DL BWPs. The issue is illustrated in FIG. 2C. FIG. 2C illustrates non-aligned BWPs for downlink (DL) and uplink (UL) communications, in accordance with some embodiments.

Disclosed techniques include systems and methods of SRS transmission across BWPs to allow sounding transmission over required BWP.

Aperiodic SRS Triggering with BWP Switching

In an embodiment, for aperiodic SRS transmission, the UE could be provided with a set of BWPs by higher layers. With the ‘SRS Request’ field in DCI format 2_3, aperiodic SRS could be triggered with BWP switching. An example of a Technical Specification change (e.g., for TS 38.212) is shown as TABLE 1 below, where the SRS request field values 01, 10, and 11 may be used to indicate the set of BWPs where SRS transmission can be performed by the UE. The SRS transmission can be performed for BWP, which are currently not active. In another example embodiment, more than 2 bits can be used to trigger SRS transmissions, where each SRS request field triggering SRS transmission may also include the set of BWPs where SRS transmission may be commenced by the UE. In the absence of the BWP set configuration for the corresponding SRS request field, the SRS transmission may be performed by the UE for the active UL BWP.

TABLE 1

| | Triggered aperiodic SRS | |
|---|---|---|
| | resource set(s) for DCI | Triggered aperiodic SRS |
| | format 0_1, 1_1, and 2_3 | resource set(s) for DCI |
| Value | configured with higher | format 2_3 configured with |
| of SRS | layer parameter srs-TPC- | higher layer parameter srs- |
| request | PDCCH-Group set to | TPC-PDCCH-Group set to |
| field | ‘typeB’ | ‘typeA’ |
| 00 | No aperiodic SRS | No aperiodic SRS resource set |
| | resource set triggered | triggered |
| 01 | SRS resource set(s) | SRS resource set(s) configured |
| | configured with higher | with higher layer parameter usage |
| | layer parameter | in SRS-ResourceSet set to |
| | aperiodicSRS- | ‘antennaSwitching‘ and |
| | ResourceTrigger set to 1 | resourceType in SRS-ResourceSet |
| | | set to ‘aperiodic‘ for a 1^{st} set of |
| | | serving cells or 1^{st} set of BWPs |
| | | configured by higher layers |
| 10 | SRS resource set(s) | SRS resource set(s) configured |
| | configured with higher | with higher layer parameter usage |
| | layer parameter | in SRS-ResourceSet set to |
| | aperiodicSRS- | ‘antennaSwitching’ and |
| | ResourceTrigger set to 2 | resourceType in SRS-ResourceSet |
| | | set to ‘aperiodic’ for a 2^{nd} set of |
| | | serving cells or 2^{nd} set of BWPs |
| | | configured by higher layers |
| 11 | SRS resource set(s) | SRS resource set(s) configured |
| | configured with higher | with higher layer parameter usage |
| | layer parameter | in SRS-ResourceSet set to |
| | aperiodicSRS- | ‘antennaSwitching’ and |
| | ResourceTrigger set to 3 | resourceType in SRS-ResourceSet |
| | | set to ‘aperiodic’ for a 3^{rd} set of |
| | | serving cells or 3^{rd} set of BWPs |
| | | configured by higher layers |

In an embodiment, to support aperiodic SRS triggering with BWP switching, an RRC layer message may be defined. In one example, the gNB may configure the index of the BWP set by using bwp-SetIndex parameter and the associated set of BWP IDs by using abwp-IndexnOneBWP-Set parameter. The configuration may also include the type of the BWP ID (bwp-Type), i.e. DL or UL. The corresponding parameters can be included in the SRS-CarrierSwitching information element, an example of which is illustrated in TABLE 2 below.

TABLE 2
SRS-CarrierSwitching information element

| -- ASN1START | |
|---|---|
| -- TAG-SRS-CARRIERSWITCHING-START | |
| SRS-CarrierSwitching ::= | SEQUENCE { |

| | |
|---|---|
| srs-SwitchFromServCellIndex | INTEGER (0..31) |

| | |
|---|---|
| srs-SwitchFromCarrier | ENUMERATED {sUL, nUL}, |

| | |
|---|---|
| srs-TPC-PDCCH-Group | CHOICE { |

| | |
|---|---|
| typeA | SEQUENCE (SIZE (1..32)) OF SRS-TPC- |

PDCCH-Config,

| | |
|---|---|
| typeB | SRS-TPC-PDCCH-Config |

| } | |
|---|---|
| monitoringCells | SEQUENCE (SIZE (1..maxNrofServingCells)) |

OF ServCellIndex

...

}

| | |
|---|---|
| SRS-TPC-PDCCH-Config ::= | SEQUENCE { |

| | |
|---|---|
| srs-CC-SetIndexlist | SEQUENCE (SIZE(1..4)) OF SRS-CC- |

SetIndex

| | |
|---|---|
| srs-BWP-SetIndexlist | SEQUENCE (SIZE(1..4)) OF SRS- |

BWP-SetIndex

| } | |
|---|---|
| SRS-CC-SetIndex ::= | SEQUENCE { |

| | |
|---|---|
| cc-SetIndex | INTEGER (0..3) |

| | |
|---|---|
| cc-IndexInOneCC-Set | INTEGER (0..7) |

| } | |
|---|---|
| SRS-BWP-SetIndex | SEQUENCE { |

| | |
|---|---|
| bwp-SetIndex | INTEGER (0..3) |

| | |
|---|---|
| bwp-IndexInOneBWP-Set | INTEGER (0..3) |

| | |
|---|---|
| bwp-Type | ENUMERATED {downlink, |

uplink}

}
-- TAG-SRS-CARRIERSWITCHING-STOP
-- ASN1STOP

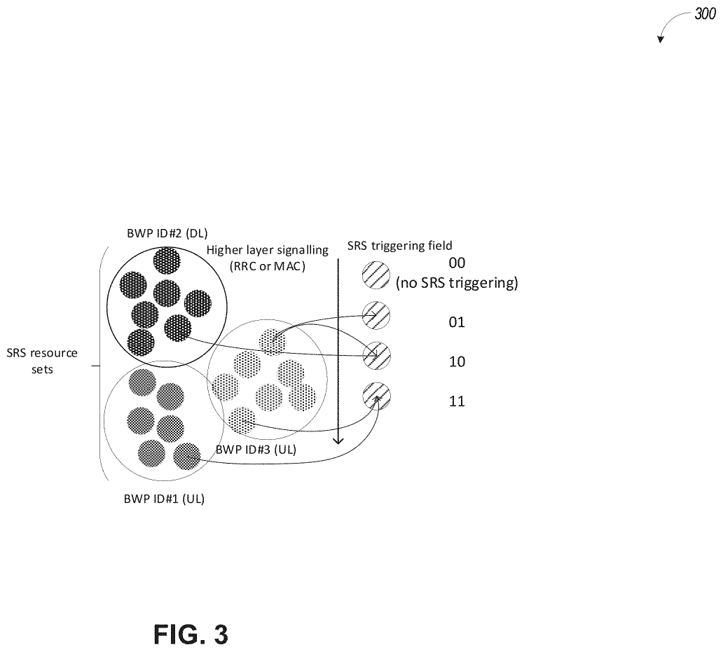

In an example embodiment, the BWP ID may be included in the SRS triggering state definition or the SRS configuration may be associated with DL BWP to allow SRS triggering for BWP other than active UL BWP. FIG. 3 illustrates association 300 between SRS resource sets in different BWPs and SRS triggering fields of DCI by using higher layer signaling (RRC or MAC CE), in accordance with some embodiments.

In other embodiments, the frequency domain position of SRS can be defined to be subcarrier 0 in a common resource block 0 irrespective of the BWP start as in the current specification. For that example, the maximum value of the freqDomainShift parameter can be extended to 2199.

In yet another embodiment, the reference point for frequency domain SRS allocation can be the corresponding lowest subcarrier of the DL BWP or lowest subcarrier of non-active UL BWP, i.e., if BWP start is smaller than or equal to the shift of SRS, the reference point for SRS is subcarrier 0 in common resource block 0, otherwise the reference point is the lowest subcarrier of the DL BWP or non-active UL BWP.

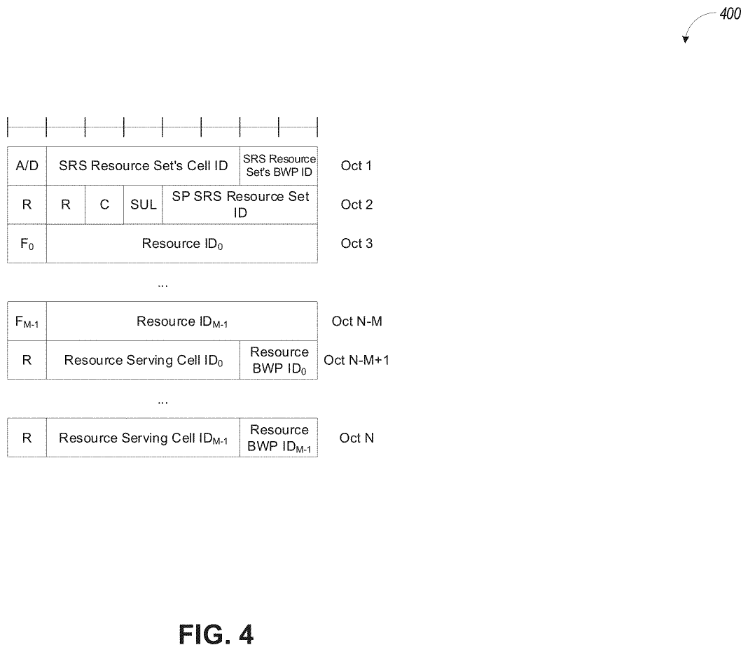

In a different embodiment, a MAC CE activation command of semi-persistent SRS transmission may also include the BWP ID of DL BWP, as illustrated by FIG. 4. FIG. 4 illustrates semi-persistent (SP) SRS activation/deactivation using a media access control (MAC) control element (CE) 400, in some embodiments.

In some embodiments, the MAC CE can also contain a type of BWP-DL or UL by using, e.g., reserved fields.

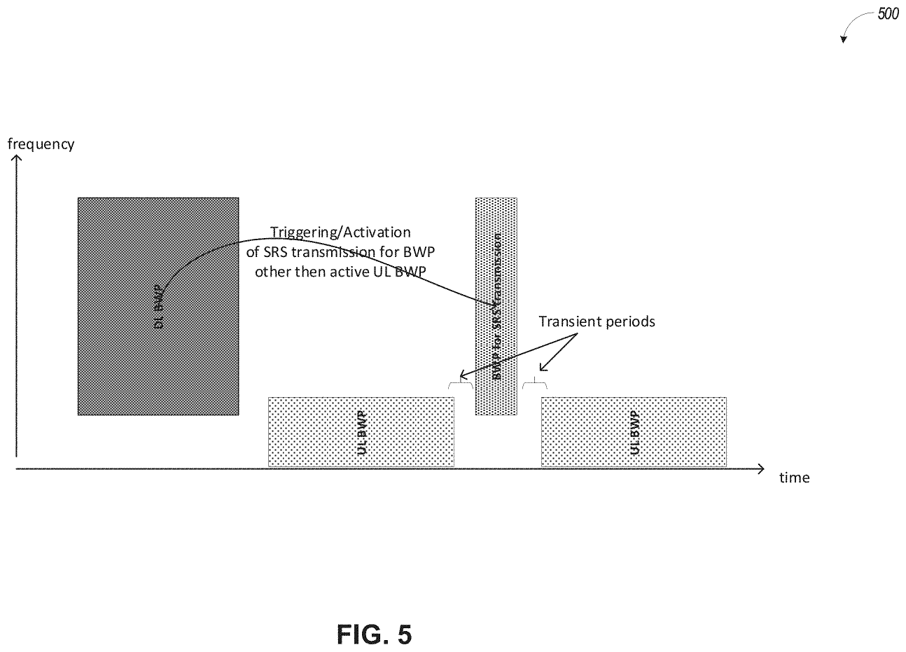

In other embodiment, if the BWP for SRS transmission is different from active UL BWP, the transient period should be allocated for the UE to allow sufficient time for RF retuning at the UE. During transient periods, the UE is not required to transmit an uplink signal in that CC. The corresponding transient periods for BWP change are illustrated in FIG. 5. FIG. 5 illustrates transient periods associated with BWP switching 500 for SRS transmission, in some embodiments.

In some aspects, system and method of sounding reference signal (SRS) transmission with bandwidth part switching are disclosed, where the method includes configuring the SRS resource set(s) at the UE. The method also includes signaling indication from gNB to the UE of the SRS transmission for the bandwidth part (BWP) other than the active uplink bandwidth part. The method also includes performing an SRS transmission from the UE per configuration on the indicated BWP. In some aspects, signaling for SRS transmission outside an active BWP includes DCI, MAC CE, and/or RRC. In some embodiments, the signaling includes the identity of the BWP or identity of the BWP set. In some embodiments, a BWP set for SRS transmission is configured by higher layers such as RRC. In some aspects, a BWP is a downlink BWP. In some embodiments, a BWP is an uplink BWP that is not active. In some embodiments, BWP for SRS transmission is indicated by the SRS request field of DCI format 23 configured with higher layer parameter srs-TPC-PDCCH-Group set to ‘typeA’. In some aspects, SRS is transmitted over active UL BWP if BWP or BWP set is not provided by higher layer signaling.

In some embodiments, frequency domain allocation of SRS is defined by a frequency shift of SRS with a maximum value of 2199 relative to subcarrier 0 of common resource block 0 of the active uplink BWP. In some aspects, frequency domain allocation of SRS is defined relative to the lowest subcarrier of the DL BWP or the lowest subcarrier of non-active UL BWP, i.e., if a BWP start is less than or equal to the frequency shift of SRS, the reference point for SRS is subcarrier 0 in common resource block 0, otherwise, the reference point is the lowest subcarrier of the DL BWP or non-active UL BWP. In some embodiments, the type of BWP, i.e. downlink or uplink, is indicated by using higher layer signaling. In some aspects, BWP identity (ID) may be included in the SRS triggering state. In some aspects, SRS resource or SRS resource set configuration is associated with downlink BWP. In some embodiments, when BWP for SRS transmission is different from active UL BWP, the transient period may be allocated for the UE to allow sufficient time for RF retuning at the UE. During a transient period, the UE is not required to transmit an uplink channel in that CC. In some embodiments, signaling indicating BWP is MAC CE activation command of semi-persistent SRS transmission, where indicated BWP corresponds to non-active uplink BWP or active downlink BWP. In some embodiments, MAC CE includes signaling of BWP type-downlink or uplink by using 1 bit.

In Rel-15/Rel-16, for antenna switching, multiple (up to two) aperiodic SRS resource set(s) can be introduced, for example, 1T4R (e.g., 1 Tx chain and 4 receive antennas). With 1T4R, two aperiodic SRS resource sets may be configured, and each set could consist of two SRS resources, or one set consists of one resource, and the other set consists of three resources. The two SRS resource sets are configured with different slotOffset and the same trigger state. Thus, the two SRS resource sets can be triggered via a single DCI.

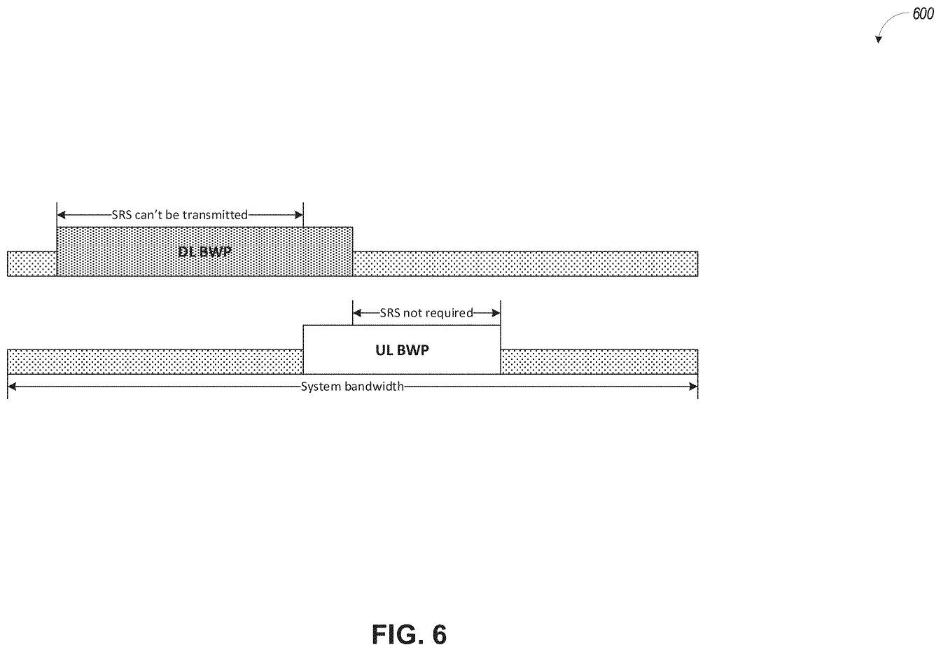

In some embodiments, a BWP can be configured to reduce UE power consumption. Since the traffic loading can be different for DL and UL, independent BWP configuration for DL and UL may be supported, i.e., the DL BWP and UL BWP may not be fully aligned in the frequency domain. The DL BWP and UL BWP may be separated apart from each other, or partially overlapped. FIG. 6 illustrates diagram 600 of non-aligned DL BWP and UL BWP, in some embodiments.

In some aspects, to obtain the CS information, SRS partial sounding can be introduced for antenna switching. The SRS could be associated with DL BWP, i.e. the SRS can be transmitted outside the active UL BWP.

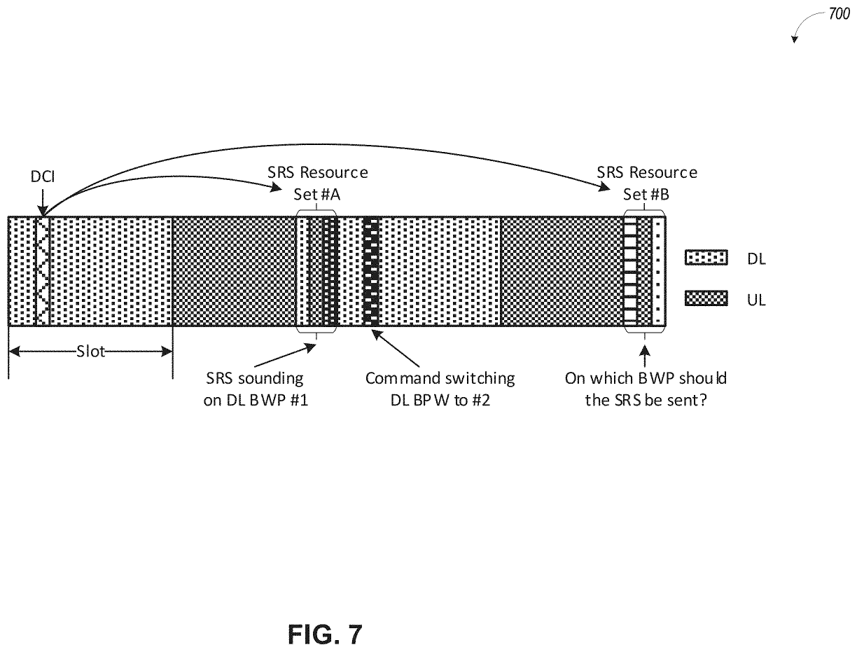

However, for antenna switching, if multiple aperiodic SRS resource sets are configured, these SRS resource sets may be transmitted over multiple slots. In this case, there might be some issue with the partial sounding operation. For example, two aperiodic SRS resource sets are triggered via a single DCI to sound DL BWP #1. If a BWP switching command is received between these two SRS resource sets, a determination can be made on which BWP should the second SRS resource set be sent. The disclosed techniques can be used to facilitate such determination. FIG. 7 illustrates BWP switching 700 for aperiodic SRS antenna switching with partial sounding, in some embodiments.

SRS Partial Sounding

In an embodiment, for SRS partial sounding, the SRS resource set signaling (e.g., as illustrated in TABLE 3) may be associated with a downlink BWP (which could be the active DL BWP). A new parameter, associatedDLBWPID may be introduced to SRS-ResourceSet signaling (as seen in TABLE 3), which indicates the ID of the DL BWP to be sounded by the SRS resources within the SRS resource set. The RRC modification is shown in TABLE 3 below. Alternatively, the new parameter could be added to SRS-Resource signaling.

TABLE 3

| SRS-ResourceSet ::= | | SEQUENCE { |
|---|---|---|
| | srs-ResourceSetId | SRS-ResourceSetId, |
| | srs-ResourceIdList | SEQUENCE (SIZE(1..maxNrofSRS- |

| | |
|---|---|
| ResourcesPerSet)) OF SRS-ResourceId | OPTIONAL, -- Cond Setup |

| | |
|---|---|
| resourceType | CHOICE { |

| | |
|---|---|
| aperiodic | SEQUENCE { |

| | |
|---|---|
| aperiodicSRS-ResourceTrigger | INTEGER (1..maxNrofSRS- |

TriggerStates-1),

| | |
|---|---|
| csi-RS | NZP-CSI-RS-ResourceId |

OPTIONAL, -- Cond NonCodebook

| | |
|---|---|
| slotOffset | INTEGER (1..32) |

OPTIONAL, -- Need S

| | |
|---|---|
| associatedDLBWPID | INTEGER (1, maxNrofBWPs), |

| ..., | |
|---|---|
| [[ | |
| aperiodicSRS-ResourceTriggerList | SEQUENCE |

(SIZE(1.. maxNrofSRS-TriggerStates-2))

OF INTEGER (1..maxNrofSRS-

TriggerStates-1) OPTIONAL -- Need M

]]

| }, | |
|---|---|
| semi-persistent | SEQUENCE { |

| | |
|---|---|
| associatedCSI-RS | NZP-CSI-RS-ResourceId |

OPTIONAL, -- Cond NonCodebook

...

| }, | |
|---|---|
| periodic | SEQUENCE { |

| | |
|---|---|
| associatedCSI-RS | NZP-CSI-RS-ResourceId |

OPTIONAL, -- Cond NonCodebook

...

}

| }, | |
|---|---|
| usage | ENUMERATED {beamManagement, |

codebook, nonCodebook, antennaSwitching},

| | |
|---|---|
| alpha | Alpha |

OPTIONAL, -- Need S

| | |
|---|---|
| p0 | INTEGER (−202..24) |

OPTIONAL, -- Cond Setup

| | |
|---|---|
| pathlossReferenceRS | CHOICE { |

| | |
|---|---|
| ssb-Index | SSB-Index, |

| | |
|---|---|
| csi-RS-Index | NZP-CSI-RS-ResourceId |

| | |
|---|---|
| } | OPTIONAL, |

-- Need M

| | |
|---|---|
| srs-PowerControlAdjustmentStates | ENUMERATED { sameAsFci2, |

| | |
|---|---|
| separateClosedLoop} | OPTIONAL, -- Need S |

...

}

In another embodiment, for antenna switching with xTyR, where x={1, 2, 4} (x is the number of Tx chains), y={1, 2, 4, 6, 8} (y is the number of Rx antennas) and x<=v, if multiple aperiodic SRS resource sets are configured, the UE may send the SRS resources over the DL BWP as indicated by the parameter of associatedDLBWPID. For the aperiodic SRS resource sets triggered by a single DCI, if the DL BWP switching command is received by the UE between the triggered aperiodic SRS resource sets, for those SRS resource sets which are not transmitted yet, one of the following options may be followed for the SRS transmission:

Option 1: after receiving the DL BWP switching command, the UE may transmit the following SRS resources over the new DL BWP.

Option 2: after receiving the DL BWP switching command, the UE may cancel the SRS transmissions which have been triggered but not transmitted yet.

Option 3: after receiving the DL BWP switching command, the UE may transmit those triggered SRS over the original DL BWP.

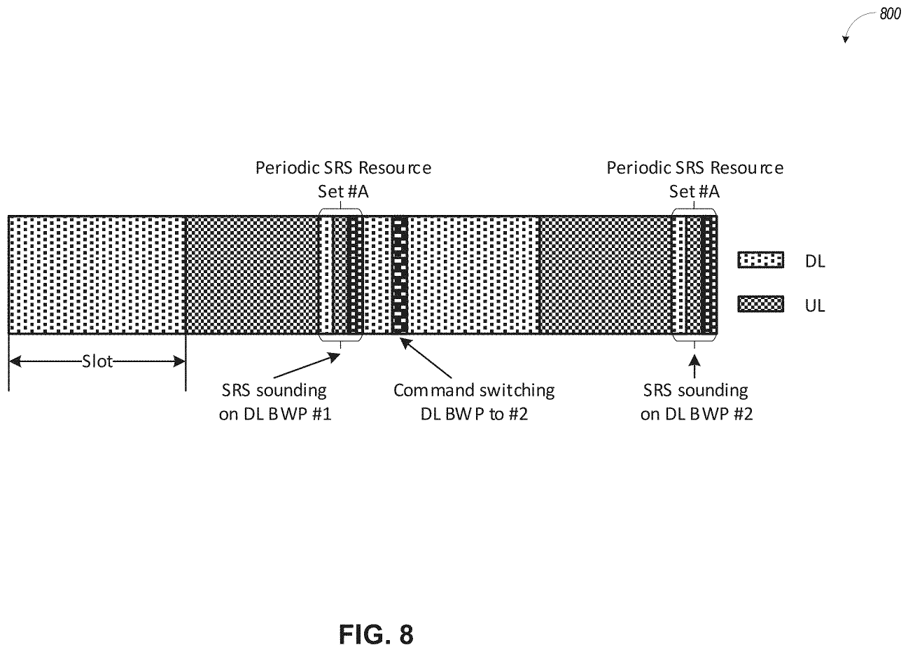

In another embodiment, for antenna switching with xTyR, for the configured periodic or semi-persistent SRS resource set, if the DL BWP switching command is received, the UE may transmit the following SRS resources over the new DL BWP. FIG. 8 illustrates BWP switching 800 for periodic SRS resource set with antenna switching, in some embodiments. Alternatively for the configured periodic or semi-persistent SRS resource set, after the DL BWP switching command is received, the UE may transmit the SRS resources over the original DL BWP until all the antennas have been sounded, and then the UE may transmit the following SRS resources over the new DL BWP.

In some embodiments, a system and method of sounding reference signal (SRS) transmission for CSI acquisition and antenna switching are disclosed. In some aspects, the SRS resource set may be associated with a downlink BWP, for example, it could be the active DL BWP. In some embodiments, a new parameter, associatedDLBWPID, may be introduced to SRS-ResourceSet, which indicates the ID of the DL BWP to be sounded by the SRS resources within the SRS resource set. In some embodiments, for antenna switching with xTyR, where x={1, 2, 4}, y={1, 2, 4, 6, 8} and x<=v, if multiple aperiodic SRS resource sets are configured, the UE may send the SRS resources over the DL BWP as indicated by the parameter of associatedDLBWPID.

In some embodiments, for the aperiodic SRS resource sets triggered by a single DCI, if the DL BWP switching command is received by the UE between the triggered aperiodic SRS resource sets, for those SRS resource sets which are not transmitted yet, one or more of the following options may be followed. In some embodiments, a first option is after receiving the DL BWP switching command, the UE may transmit the following SRS resources over the new DL BWP. In some aspects, a second option is after receiving the DL BWP switching command, the UE may cancel the SRS transmissions which have been triggered but not transmitted yet. In some embodiments, a third option is after receiving the DL BWP switching command, the UE may transmit those triggered SRS over the original DL BWP. In some aspects, for antenna switching with xTyR, for the configured periodic or semi-persistent SRS resource set, if the DL BWP switching command is received, the UE may transmit the following SRS resources over the new DL BWP. In some embodiments, for antenna switching with xTyR, for the configured periodic or semi-persistent SRS resource set, after the DL BWP switching command is received, the UE may transmit the SRS resources over the original DL BWP until all the antennas have been sounded. Then the UE may transmit the following SRS resources over the new DL BWP.

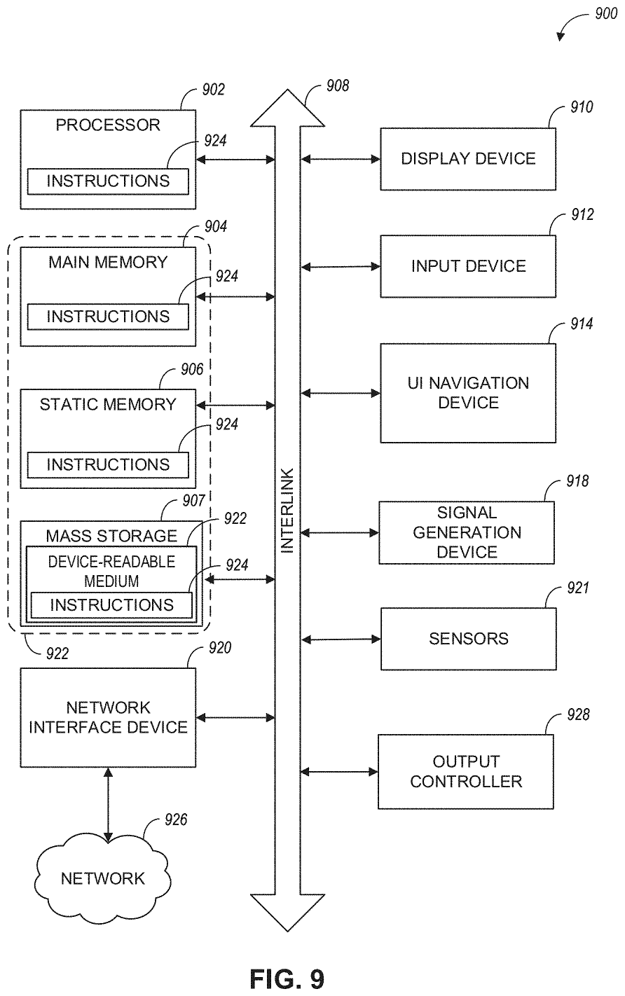

FIG. 9 illustrates a block diagram of a communication device such as an evolved Node-B (eNB), a next generation Node-B (gNB), an access point (AP), a wireless station (STA), a mobile station (MS), or a user equipment (UE), in accordance with some aspects and to perform one or more of the techniques disclosed herein. In alternative aspects, the communication device 900 may operate as a standalone device or may be connected (e.g., networked) to other communication devices.

Circuitry (e.g., processing circuitry) is a collection of circuits implemented in tangible entities of the device 900 that include hardware (e.g., simple circuits, gates, logic, etc.). Circuitry membership may be flexible over time. Circuitries include members that may, alone or in combination, perform specified operations when operating. In an example, the hardware of the circuitry may be immutably designed to carry out a specific operation (e.g., hardwired). In an example, the hardware of the circuitry may include variably connected physical components (e.g., execution units, transistors, simple circuits, etc.) including a machine-readable medium physically modified (e.g., magnetically, electrically, moveable placement of invariant massed particles, etc.) to encode instructions of the specific operation.

In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the device 900 follow.

In some aspects, the device 900 may operate as a standalone device or may be connected (e.g., networked) to other devices. In a networked deployment, the communication device 900 may operate in the capacity of a server communication device, a client communication device, or both in server-client network environments. In an example, the communication device 900 may act as a peer communication device in a peer-to-peer (P2P) (or other distributed) network environment. The communication device 900 may be a UE, eNB, PC, a tablet PC, an STB, a PDA, a mobile telephone, a smartphone, a web appliance, a network router, switch or bridge, or any communication device capable of executing instructions (sequential or otherwise) that specify actions to be taken by that communication device. Further, while only a single communication device is illustrated, the term “communication device” shall also be taken to include any collection of communication devices that individually or jointly execute a set (or multiple sets) of instructions to perform any one or more of the methodologies discussed herein, such as cloud computing, software as a service (SaaS), and other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a communication device-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using the software, the general-purpose hardware processor may be configured as respective different modules at different times. The software may accordingly configure a hardware processor, for example, to constitute a particular module at one instance of time and to constitute a different module at a different instance of time.

The communication device (e.g., UE) 900 may include a hardware processor 902 (e.g., a central processing unit (CPU), a graphics processing unit (GPU), a hardware processor core, or any combination thereof), a main memory 904, a static memory 906, and mass storage 907 (e.g., hard drive, tape drive, flash storage, or other block or storage devices), some or all of which may communicate with each other via an interlink (e.g., bus) 908.

The communication device 900 may further include a display device 910, an alphanumeric input device 912 (e.g., a keyboard), and a user interface (UI) navigation device 914 (e.g., a mouse). In an example, the display device 910, input device 912, and UI navigation device 914 may be a touchscreen display. The communication device 900 may additionally include a signal generation device 918 (e.g., a speaker), a network interface device 920, and one or more sensors 921, such as a global positioning system (GPS) sensor, compass, accelerometer, or another sensor. The communication device 900 may include an output controller 928, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 907 may include a communication device-readable medium 922, on which is stored one or more sets of data structures or instructions 924 (e.g., software) embodying or utilized by any one or more of the techniques or functions described herein. In some aspects, registers of the processor 902, the main memory 904, the static memory 906, and/or the mass storage 907 may be, or include (completely or at least partially), the device-readable medium 922, on which is stored the one or more sets of data structures or instructions 924, embodying or utilized by any one or more of the techniques or functions described herein. In an example, one or any combination of the hardware processor 902, the main memory 904, the static memory 906, or the mass storage 916 may constitute the device-readable medium 922.

As used herein, the term “device-readable medium” is interchangeable with “computer-readable medium” or “machine-readable medium”. While the communication device-readable medium 922 is illustrated as a single medium, the term “communication device-readable medium” may include a single medium or multiple media (e.g., a centralized or distributed database, and/or associated caches and servers) configured to store one or more instructions 924. The term “communication device-readable medium” is inclusive of the terms “machine-readable medium” or “computer-readable medium”, and may include any medium that is capable of storing, encoding, or carrying instructions (e.g., instructions 924) for execution by the communication device 900 and that cause the communication device 900 to perform any one or more of the techniques of the present disclosure, or that is capable of storing, encoding or carrying data structures used by or associated with such instructions. Non-limiting communication device-readable medium examples may include solid-state memories and optical and magnetic media. Specific examples of communication device-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, communication device-readable media may include non-transitory communication device-readable media. In some examples, communication device-readable media may include communication device-readable media that is not a transitory propagating signal.

The instructions 924 may further be transmitted or received over a communications network 926 using a transmission medium via the network interface device 920 utilizing any one of a number of transfer protocols. In an example, the network interface device 920 may include one or more physical jacks (e.g., Ethernet, coaxial, or phone jacks) or one or more antennas to connect to the communications network 926. In an example, the network interface device 920 may include a plurality of antennas to wirelessly communicate using at least one of single-input-multiple-output (SIMO), MIMO, or multiple-input-single-output (MISO) techniques. In some examples, the network interface device 920 may wirelessly communicate using Multiple User MIMO techniques.

The term “transmission medium” shall be taken to include any intangible medium that is capable of storing, encoding, or carrying instructions for execution by the communication device 900, and includes digital or analog communications signals or another intangible medium to facilitate communication of such software. In this regard, a transmission medium in the context of this disclosure is a device-readable medium.

Although an aspect has been described with reference to specific exemplary aspects, it will be evident that various modifications and changes may be made to these aspects without departing from the broader scope of the present disclosure. Accordingly, the specification and drawings are to be regarded in an illustrative rather than a restrictive sense. This Detailed Description, therefore, is not to be taken in a limiting sense, and the scope of various aspects is defined only by the appended claims, along with the full range of equivalents to which such claims are entitled.

What is claimed is:

1. An apparatus to be used in a user equipment (UE), the apparatus comprising:
processing circuitry, wherein to configure the UE for 5G-New Radio (NR) communications, the processing circuitry is to:
decode higher layer signaling received from a base station, the higher layer signaling to configure a plurality of bandwidth parts (BWPs) for uplink (UL) and downlink (DL) communication with the base station;
decode downlink control information (DCI) received on a physical downlink control channel (PDCCH), the DCI including a field triggering sounding reference signal (SRS) reporting, the field further indicating a subset of the plurality of BWPs for the SRS reporting;
encode an SRS for transmission to the base station using a first BWP of the subset of the plurality of BWPs indicated by the field to perform the SRS reporting; and
encode an UL communication for an UL transmission using a second BWP of the plurality of BWPs, the second BWP being non-overlapping with the subset of the plurality of BWPs; and
a memory coupled to the processing circuitry and configured to store the DCI.

2. The apparatus of claim 1, wherein the field is an SRS request field of the DCI, and the processing circuitry is to select the subset of the plurality of BWPs based on a value of the SRS request field.

3. The apparatus of claim 1, wherein the UL transmission is a physical uplink control channel (PUCCH) transmission or a physical uplink shared channel (PUSCH) transmission.

4. The apparatus of claim 1, wherein the processing circuitry is to:
decode a DL communication comprising radio resource control (RRC) signaling, the RRC signaling including a BWP set index of the subset of the plurality of BWPs and a BWP identification (ID) of the first BWP; and
select the first BWP for transmission of the SRS based on the BWP set index and the BWP ID.

5. The apparatus of claim 4, wherein the RRC signaling is an SRS Carrier Switching Information Element (IE).

6. The apparatus of claim 1, wherein the processing circuitry is to:
decode layer 2 (L2) signaling, the L2 signaling including a media access control (MAC) control element (CE), the MAC CE activating semi-persistent transmission of the SRS and including a BWP identification (ID).

7. The apparatus of claim 6, wherein the processing circuitry is to:
encode the SRS for semi-persistent transmission to the base station using a third BWP of the plurality of BWPs, the third BWP selected based on the BWP ID in the MAC CE.

8. The apparatus of claim 1, wherein the processing circuitry is to:
decode second higher layer signaling, the second higher layer signaling including a BWP switching command; and
switch from the first BWP of the subset to a third BWP indicated by the BWP switching command.

9. The apparatus of claim 8, wherein the processing circuitry is to:
perform SRS sounding of the third BWP to generate a subsequent SRS; and
encode the subsequent SRS for transmission to the base station using the third BWP.

10. The apparatus of claim 1, further comprising transceiver circuitry coupled to the processing circuitry; and, one or more antennas coupled to the transceiver circuitry.

11. A non-transitory computer-readable storage medium that stores instructions for execution by one or more processors of a base station, the instructions to configure the base station for 5G-New Radio (NR) communications, and to cause the base station to perform operations comprising:
encoding higher layer signaling for transmission to a user equipment (UE), the higher layer signaling to configure a plurality of bandwidth parts (BWPs) for uplink (UL) and downlink (DL) communication between the UE and the base station;
encoding downlink control information (DCI) for transmission on a physical downlink control channel (PDCCH), the DCI including a field triggering sounding reference signal (SRS) reporting, the field further indicating a subset of the plurality of BWPs for the SRS reporting;
decoding an SRS received from the UE using a first BWP of the subset of the plurality of BWPs indicated by the field to perform the SRS reporting;
calculating a precoder based on the SRS; and
encoding a DL communication comprising a physical downlink shared channel (PDSCH) for transmission to the UE using the precoder.

12. The computer-readable storage medium of claim 11, wherein executing the instructions further causes the base station to perform operations comprising:
encoding radio resource control (RRC) signaling, the RRC signaling including a BWP set index of the subset of the plurality of BWPs and a BWP identification (ID) of the first BWP, wherein the first BWP is selected based on the BWP set index and the BWP ID.

13. The computer-readable storage medium of claim 12, wherein the RRC signaling is an SRS Carrier Switching Information Element (IE).

14. A non-transitory computer-readable storage medium that stores instructions for execution by one or more processors of a user equipment (UE), the instructions to configure the UE for 5G-New Radio (NR) communications, and to cause the UE to perform operations comprising:
decoding higher layer signaling received from a base station, the higher layer signaling to configure a plurality of bandwidth parts (BWPs) for uplink (UL) and downlink (DL) communication with the base station;
decoding downlink control information (DCI) received on a physical downlink control channel (PDCCH), the DCI including a field triggering sounding reference signal (SRS) reporting, the field further indicating a subset of the plurality of BWPs for the SRS reporting;
encoding an SRS for transmission to the base station using a first BWP of the subset of the plurality of BWPs indicated by the field to perform the SRS reporting; and
encoding an UL communication for UL transmission using a second BWP of the plurality of BWPs, the second BWP being non-overlapping with the subset of the plurality of BWPs.

15. The computer-readable storage medium of claim 14, wherein the UL transmission is a physical uplink control channel (PUCCH) transmission or a physical uplink shared channel (PUSCH) transmission.

16. The computer-readable storage medium of claim 14, wherein executing the instructions further causes the UE to perform operations comprising:
decoding a DL communication with radio resource control (RRC) signaling, the RRC signaling including a BWP set index of the subset of the plurality of BWPs and a BWP identification (ID) of the first BWP; and
selecting the first BWP for transmission of the SRS based on the BWP set index and the BWP ID.

17. The computer-readable storage medium of claim 14, wherein executing the instructions further causes the UE to perform operations comprising:
decoding layer 2 (L2) signaling, the L2 signaling including a media access control (MAC) control element (CE), the MAC CE activating semi-persistent transmission of the SRS and including a BWP identification (ID).

18. The computer-readable storage medium of claim 17, wherein executing the instructions further causes the UE to perform operations comprising:
encoding the SRS for semi-persistent transmission to the base station using a third BWP of the plurality of BWPs, the third BWP selected based on the BWP ID in the MAC CE.

19. The computer-readable storage medium of claim 14, wherein executing the instructions further causes the UE to perform operations comprising:
decoding second higher layer signaling, the second higher layer signaling including a BWP switching command; and
switching from the first BWP of the subset to a third BWP indicated by the BWP switching command.

20. The computer-readable storage medium of claim 19, wherein executing the instructions further causes the UE to perform operations comprising:
performing SRS sounding of the third BWP to generate a subsequent SRS; and
encoding the subsequent SRS for transmission to the base station using the third BWP.
